(19) United States
(12) Patent Application Publication
(10) Pub. No.: US 2023/0406062 A1
(43) Pub. Date: Dec. 21, 2023

(54) VEHICLE HVAC CONTROL SYSTEMS

(71) Applicant: Toyota Motor Engineering & Manufacturing North America, Inc., Plano, TX (US)

(72) Inventors: Timothy Wang, Ann Arbor, MI (US); Roger Akira Kyle, Aubrey, TX (US); Bryan Else Yamasaki, Frisco, TX (US); Justin K. Shen, Canton, MI (US); Prince R. Remegio, McKinney, TX (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 17/845,045

(22) Filed: Jun. 21, 2022

(51) Int. Cl. B60H 1/00; G06V 10/74; G06V 20/59; G06V 20/60

(52) U.S. Cl. CPC B60H 1/00742; B60H 1/00871; G06V 20/60; G06V 20/59; G06V 10/74

(57) ABSTRACT

A control system includes at least one temperature sensor positioned in an interior of a vehicle, an imaging device positioned at a footwell of the vehicle, and a controller communicatively coupled to the temperature sensor and the imaging device. The controller is configured to: determine an interior temperature from a temperature signal received from the temperature sensor, determine a footwear type from image data received from the imaging device, and direct air to the footwell when the footwear type is a predetermined footwear type and the interior temperature exceeds a threshold value.

### TECHNICAL FIELD

The present specification generally relates to vehicle control systems, and more specifically, to systems for controlling HVAC systems in a vehicle.

### BACKGROUND

Traditional vehicle heating, ventilation, and air conditioning (HVAC) systems can direct air flow to various locations in the vehicle, such as locations at or near a head or feet of a passenger or a driver. Some vehicle passengers or drivers may desire an automatic system that anticipates needs and provides cooling or warming air without inputs.

### SUMMARY

In one embodiment, a control system includes at least one temperature sensor positioned in an interior of a vehicle, an imaging device positioned at a footwell of the vehicle, and a controller communicatively coupled to the temperature sensor and the imaging device. The controller is configured to: determine an interior temperature from a temperature signal received from the temperature sensor, determine a footwear type from image data received from the imaging device, and direct air to the footwell when the footwear type is a predetermined footwear type and the interior temperature exceeds a threshold value.

In another embodiment, a control system includes at least one temperature sensor at a footwell of a vehicle, an imaging device positioned at the footwell, and a controller communicatively coupled to the temperature sensor and the imaging device. The controller is configured to: determine a temperature of the footwell from a temperature signal received from the at least one temperature sensor, determine a footwear type from image data received from the imaging device, and direct air to the footwell when the footwear type is a predetermined type and the temperature of the footwell is below a threshold value.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a control system in a footwell of a vehicle, according to one or more embodiments shown and described herein;

FIG. 2 schematically depicts the control system of FIG. 1, according to one or more embodiments shown and described herein; and

FIG. 3 depicts a flowchart of operation of the control system of FIG. 1, according to one or more embodiments shown and described herein.

### DETAILED DESCRIPTION

The present disclosure generally relates to a vehicle system that is particularly configured to determine footwear worn by a driver and/or one or more occupants of a vehicle and based on the determined footwear, adjust the HVAC system of the vehicle accordingly. For example, if the footwear type is of the sort that provides minimal or no heat insulation (e.g., sandals, flip flops, or the like) and the temperature inside and/or outside the vehicle is lower than a threshold, then the vehicle system may automatically direct heating air to the footwells of the vehicle to warm the driver's and/or the one or more passengers' feet. In another example, if the footwear type is of the sort that insulates feet (e.g., boots or the like) and the temperature inside and/or outside the vehicle is higher than a threshold, then the vehicle system may automatically direct cooling air to the footwells of the vehicle to cool the driver's and/or the one or more passengers' feet. It should be appreciated that such a vehicle system may be more intuitive in anticipating occupants' needs and allows for automatic HVAC adjustment without any user input. Other advantages will be apparent from the following disclosure.

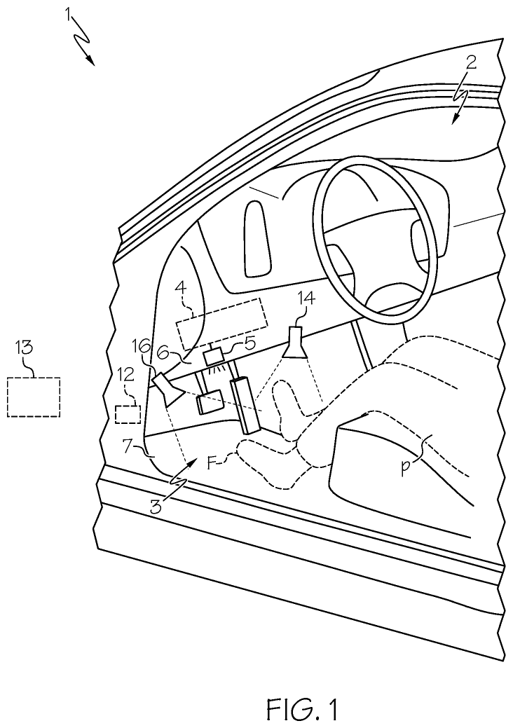

FIG. 1 generally depicts one embodiment of a control system for automatically controlling an HVAC system of a vehicle. The control system generally includes a plurality of temperature sensors, an imaging device positioned in a footwell of the vehicle, and a controller communicatively coupled to the temperature sensors and the imaging device. The temperature sensors obtain temperature readings around the vehicle, including a temperature of a passenger's feet or footwear, and a temperature of the air inside and/or outside of the vehicle. The imaging device captures images and transfers image data to the controller where the controller compares the image data to a database of images that correspond to predetermined footwear types. The controller then activates the HVAC system of the vehicle to direct air to the footwell when the controller determines whether the detected temperatures are below corresponding threshold values and whether the passenger is wearing a predetermined type of footwear. Various embodiments of the control system and the operation of the control system will be described in more detail herein.

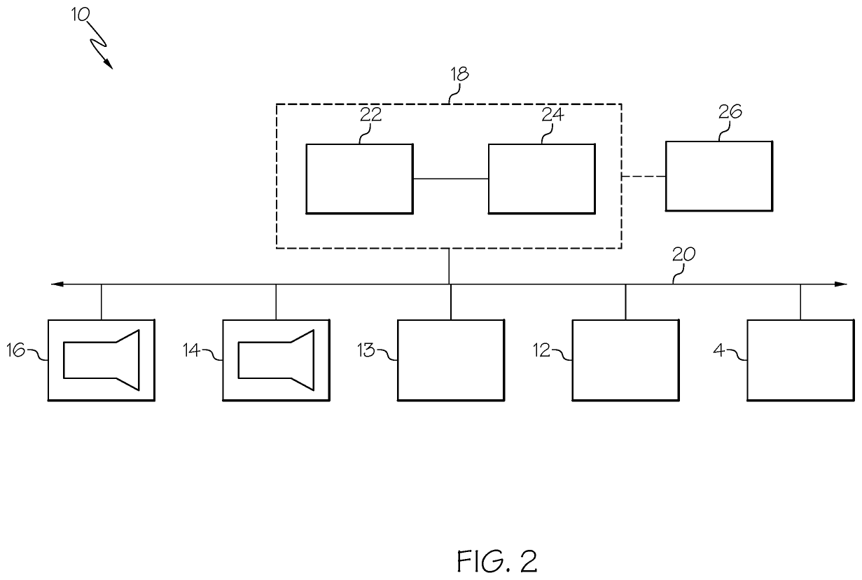

Referring now to FIGS. 1 and 2, a control system 10 for a vehicle 1 is depicted. The vehicle 1 may include a passenger compartment 2 having a footwell 3 with a floor 7, and an HVAC system 4 for conditioning the air in the passenger compartment 2. The control system 10 may be communicatively coupled to the HVAC system 4 and configured to control operation of the HVAC system 4. The control system 10 controls operation of the HVAC system 4 to direct air flow throughout the passenger compartment 2. The HVAC system 4 may be any traditional vehicle HVAC system that conditions the temperature of the air flow. The HVAC system 4 includes a blower 5 that directs air flow to locations in the passenger compartment 2 including the footwell 3. The blower 5 may be positioned within a dash panel 6 above the footwell 3 and directed toward the footwell 3 such that air flow is directed into the footwell 3 and/or at feet or footwear F of a passenger P. It should be appreciated that the term “passenger” as used herein includes both a driver of a vehicle as well as non-driver occupants of the vehicle 1. The HVAC system 4 includes a plurality of blowers positioned throughout the vehicle 1 for directing air to a plurality of locations of the passenger compartment 2, such as directing air flow at a torso or hands of the passenger P. As used herein, the “blower” may be a blower motor that directs air through a vent in the interior of the vehicle 1. The air flow directed by the blower 5 of the HVAC system 4 may be warm air or cold air. “Warmed air” may generally be air that has a relatively higher temperature than an average ambient air temperature. For example, illustrative examples of warm air temperatures include, but are not limited to, a temperature of about 70° F., about 80° F., about 90° F., or greater. “Cooled air” may generally be air that has a relatively lower temperature than an average ambient air temperature. For example, illustrative examples of cooled air temperatures include, but are not limited to, a temperature less than about 70° F., less than about 60° F., less than about 50° F., or the like.

The control system 10 may include an interior temperature sensor 12, an exterior temperature sensor 13, an imaging device 14, a footwell temperature sensor 16, a controller 18, and a communication path 20 communicatively coupling the controller 18 to the interior temperature sensor 12, the exterior temperature sensor 13, the imaging device 14, the footwell temperature sensor 16, and the HVAC system 4. The controller 18 includes a processor 22 and a non-transitory memory 24 to which various components are communicatively coupled. In some embodiments, the processor 22 and the non-transitory memory 24 and/or the other components are included within a single device. In other embodiments, the processor 22 and the non-transitory memory 24 and/or the other components may be distributed among a plurality of devices that are communicatively coupled. The controller 18 includes non-transitory memory 24 that stores a set of machine-readable instructions. The processor 22 executes the machine-readable instructions stored in the non-transitory memory 24. The non-transitory memory 24 may include RAM, ROM, flash memories, hard drives, or any device capable of storing machine-readable instructions such that the machine-readable instructions can be accessed by the processor 22. Accordingly, the control system 10 described herein may be implemented in any conventional computer programming language, as pre-programmed hardware elements, or as a combination of hardware and software components. The non-transitory memory 24 may be implemented as one memory module or a plurality of memory modules.

The processor 22 may be any device capable of executing machine-readable instructions. For example, the processor 22 may be an integrated circuit, a microchip, a computer, or any other computing device. The non-transitory memory 24 and the processor 22 are coupled to the communication path 20 that provides signal interconnectivity between various components and/or modules of the control system 10. Accordingly, the communication path 20 may communicatively couple any number of processors with one another, and allow the modules coupled to the communication path 20 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

As schematically depicted in FIG. 2, the communication path 20 communicatively couples the processor 22 and the non-transitory memory 24 of the controller 18 with a plurality of other components of the control system 10. The controller 18 may be configured to send and receive signals from the interior temperature sensor 12, the exterior temperature sensor 13, the imaging device 14, the footwell temperature sensor 16, and the HVAC system 4 as will be described in further detail herein.

The interior temperature sensor 12 may be configured to detect an interior temperature of the vehicle 1. The interior temperature may be an average temperature of air inside the passenger compartment 2 of the vehicle 1. The interior temperature sensor 12 may be positioned inside the passenger compartment 2, or interior 2, of the vehicle. The interior temperature sensor 12 may be any sensor capable of detecting an air temperature, such as, for example, a thermistor, a thermocouple, a thermopile, a resistance temperature detector, or the like.

The exterior temperature sensor 13 may be configured to detect an exterior temperature of the vehicle 1. The exterior temperature may be an average temperature of air at any location outside of the passenger compartment 2 of the vehicle 1. The exterior temperature sensor 13 may be positioned outside the passenger compartment 2 of the vehicle 1. The exterior temperature sensor 13 may be any sensor capable of detecting an air temperature, such as, for example, a thermistor, a thermocouple, a thermopile, a resistance temperature detector, or the like.

The footwell temperature sensor 16 may be positioned in the footwell 3 and directed to the floor 7 of the footwell 3 such that a temperature sensed by the footwell temperature sensor 16 generally corresponds to a temperature of the footwell. The footwell temperature sensor 16 may be fixed to a panel in the footwell 3, such as the dash panel 6. The footwell temperature sensor 16 may be configured to detect a footwell temperature in the footwell 3. In embodiments, the temperature in the footwell 3 may be a temperature of the foot or footwear F of the passenger P. In such embodiments, the footwell temperature sensor 16 may be a thermal camera. The thermal camera may be mounted in the footwell 3 above the floor 7 and directed toward the floor 7 to image the floor 7 and the feet or footwear F of the passenger P positioned between the floor 7 and the footwell temperature sensor 16. In other embodiments, the temperature in the footwell 3 may be a temperature of air in the footwell 3. In such embodiments, the footwell temperature sensor 16 may be any sensor capable of detecting an air temperature, such as, for example, a thermistor, a thermocouple, a thermopile, a resistance temperature detector, or the like.

The imaging device 14 may be positioned in the footwell 3 adjacent to the footwell temperature sensor 16, and directed toward the floor 7 of the footwell 3. The imaging device 14 may be coupled to a panel in the footwell 3 (e.g., in a manner similar to that of the footwell temperature sensor 16), such as the dash panel 6. The imaging device 14 may be configured to capture images of the footwear F of the passenger P. The imaging device 14 may be any device capable of capturing images, such as, for example, a camera (including both still image capture cameras, cameras that capture a series of images in rapid succession (e.g., a burst mode camera), and/or a video camera).

The controller 18 is configured to receive a first temperature signal from the interior temperature sensor 12 indicative of the detected air temperature of the vehicle 1 and determine the air temperature from the temperature signal. The controller 18 may be configured to receive another temperature signal from the exterior temperature sensor 13 indicative of the detected air temperature outside of the vehicle 1, and determine the air temperature from the temperature signal. The controller 18 is configured to determine whether the air temperature detected from either of the interior temperature sensor 12 and/or the exterior temperature sensor 13 exceeds a first threshold value by comparing the detected air temperature with the first threshold value. The air temperature may exceed the first threshold value when the air temperature is below the first threshold value. The first threshold value may be a predetermined value, such as, for example, about 32° Fahrenheit. However, the first threshold value may be any predetermined value that could potentially be considered cold to an observer, such as less than about 20° Fahrenheit, less than about 40° Fahrenheit, less than about 50° Fahrenheit, less than about 60° Fahrenheit, or the like. In some embodiments, the air temperature may exceed the first threshold value when the air temperature is above the first threshold value. In such embodiments, the predetermined value could potentially be considered hot to an observer, such as greater than about 70° Fahrenheit, greater than about 80° Fahrenheit, greater than about 90° Fahrenheit, or greater than about 100° Fahrenheit.

The controller 18 may be configured to receive a second temperature signal, or footwell temperature signal, from the footwell temperature sensor 16 indicative of the detected temperature in the footwell 3 and determine the temperature in the footwell 3 from the second temperature signal. The controller 18 may be configured to determine whether the temperature in the footwell 3 exceeds a second threshold value by comparing the detected temperature in the footwell 3 with the second threshold value. In some embodiments, the temperature in the footwell 3 may exceed the second threshold value when the temperature in the footwell 3 is below the second threshold value. Alternatively, in other embodiments, the temperature in the footwell 3 may exceed the second threshold value when the temperature in the footwell 3 is above the second threshold value.

In embodiments where the temperature in the footwell 3 exceeds the second threshold value when the temperature is below the second threshold, the second threshold value may be any predetermined value that could potentially be considered cold to an observer, such as less than about 20° Fahrenheit, less than about 40° Fahrenheit, less than about 50° Fahrenheit, less than about 60° Fahrenheit, or the like. In embodiments where the temperature in the footwell 3 exceeds the second threshold value when the temperature is above the second threshold, the predetermined value could potentially be considered hot to an observer, such as greater than about 70° Fahrenheit, greater than about 80° Fahrenheit, greater than about 90° Fahrenheit, or greater than about 100° Fahrenheit.

The controller 18 may be configured to receive image data from the imaging device 14 indicative of an image of the footwear F of the passenger Pin the footwell 3. The controller 18 may be configured to determine a footwear type of the footwear F of the passenger P from the image data. The controller 18 may be further configured to determine whether the detected footwear type is one of at least one predetermined footwear type. The controller 18 may be communicatively coupled to a database of images 26 that stores a plurality of images that correspond to the at least one predetermined footwear type. The controller 18 may compare the image data from the imaging device 14 to the plurality of images of the database 26, and select a determined footwear type from a matching image of the plurality of images. The matching image may be an image that includes a footwear that is the same as the footwear in the image data from the imaging device 14 or is substantially similar to the footwear in the image data (e.g., sharing a number of similar features above a predetermined threshold). Each of the plurality of images of the database 26 may correspond to the at least one predetermined footwear type. In some embodiments, machine learning may be employed to determine the footwear in the image from a database of footwear images, where a machine learning device is trained to analyze image data, capture features from the image data, and compare the features to features of known footwear types.

The footwear type may be related to a type of footwear that is a shoe lacking insulation, including, but not limited to, tennis shoes or sneakers, slippers, sandals, dress shoes, or the like. The predetermined footwear types may include the footwear types recited above, including tennis shoes or sneakers, slippers, sandals, dress shoes, boots, or the like. The predetermined footwear types may additionally include no shoes for cases when the passenger P is barefoot. In some embodiments, the predetermined footwear types may be any type of footwear excluding winter footwear, such as boots and/or insulated shoes. In embodiments where each of the air temperature and the footwell temperature exceed the first threshold value and the second threshold value, respectively, when the air temperature and the footwell temperature are above the threshold values, the footwear type may be related to a type of footwear that includes insulation, such as boots.

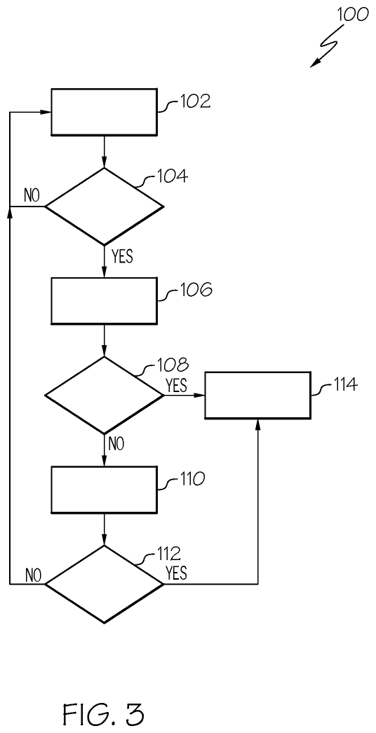

The operation of the control system 10 will now be described with reference to the method 100 depicted in FIG. 3. The controller 18 may be configured to, at block 102, determine the interior temperature from the first temperature signal received from the interior temperature sensor 12 indicative of the air temperature inside of the vehicle 1, and determine the exterior temperature from the temperature signal received from the exterior temperature sensor 13 indicative of the air temperature outside of the vehicle 1. At block 104, the controller 18 may be configured to compare each of the interior temperature and the exterior temperature to the first threshold value to determine whether either of the air temperatures exceed the first threshold value. If either of the air temperatures exceed the first threshold value, the method 100 proceeds to block 106, where the controller 18 may be configured to determine the footwear type of the footwear F of the passenger P from the image data received from the imaging device 14. The controller 18 may compare the image data to the images of the database 26 to determine the footwear type. At block 108, the controller 18 may determine whether the determined footwear type is one of the predetermined footwear types. If the footwear type is one of the predetermined footwear types, the method 100 may proceed to block 114, where the controller 18 operates the HVAC system 4 to activate the blower 5 to direct air to the footwell 3. The controller 18 may operate the HVAC system 4 to direct either warmed air or cold air to the feet of the passenger P. The temperature of the air from the HVAC system 4 may be a predetermined temperature that is, for example, greater or less than the detected air temperature, greater or less than the temperature in the footwell 3, greater or less than the average body temperature, or the like. In embodiments where the air temperature exceeds the first threshold value when the air temperature is below the first threshold value and the footwell temperature exceeds the second threshold value when the footwell temperature is below the second threshold value, the HVAC system 4 may direct warmed air to the feet of the passenger P. In embodiments where the air temperature exceeds the first threshold value when the air temperature is above the first threshold value and the footwell temperature exceeds the second threshold value when the footwell temperature is above the second threshold value, the HVAC system 4 may direct cold air to the feet of the passenger P.

If the footwear type is not one of the predetermined footwear types, the method 100 proceeds to block 110, where the controller 18 determines the temperature in the footwell 3 from the second temperature signal received from the footwell temperature sensor 16. At block 112, the controller 18 is configured to compare the temperature in the footwell 3 to the second threshold value to determine whether the temperature in the footwell 3 exceeds the second threshold value. If the temperature in the footwell 3 exceeds the second threshold value, the method proceeds to block 114 to direct air to the footwell 3. If the temperature in the footwell 3 does not exceed the second threshold value, the method 100 may terminate, or proceed back to block 102.

It should now be understood a control system for controlling operation of an HVAC system of a vehicle. The control system includes a plurality of sensors that detect the air temperature inside or around the vehicle, the temperature of the feet of a passenger, and the type of footwear that the passenger is wearing. The control system activates the HVAC system to direct air flow to the footwell of the vehicle when the air temperature exceeds a threshold value and the temperature of the footwell exceeds another threshold value and/or the type of footwear is a predetermined type of footwear.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A control system, comprising:
at least one temperature sensor positioned in an interior of a vehicle;
an imaging device positioned at a footwell of the vehicle; and
a controller communicatively coupled to the temperature sensor and the imaging device, the controller configured to:
determine an interior temperature from a temperature signal received from the temperature sensor,
determine a footwear type from image data received from the imaging device, and
direct air to the footwell when the footwear type is a predetermined footwear type and the interior temperature exceeds a threshold value.

2. The control system of claim 1, wherein determining the footwear type comprises:
comparing the image data received from the imaging device to a plurality of images in a database of images, and
selecting a determined footwear type from a matching image of the plurality of images.

3. The control system of claim 2, wherein each of the plurality of images correspond to the at least one predetermined footwear type.

4. The control system of claim 1, wherein the predetermined footwear type is a shoe lacking insulation.

5. The control system of claim 1, wherein the predetermined footwear type is a sandal or a slipper.

6. The control system of claim 1, wherein:
the at least one temperature sensor comprises a footwell temperature sensor configured to detect a footwell temperature, and
the controller is further configured to:
determine the footwell temperature from a footwell temperature signal received from the footwell temperature sensor,
determine the footwell temperature is below a second threshold value, and
direct air to the footwell when the footwell temperature is below the second threshold value.

7. The control system of claim 6, wherein the controller is further configured to direct air to the footwell when the footwell temperature is below the second threshold value and the footwear type is the predetermined footwear type.

8. The control system of claim 1, further comprising an exterior temperature sensor communicatively coupled to the controller, wherein the controller is further configured to:
determine an exterior temperature from a temperature signal received from the exterior temperature sensor, and
direct air to the footwell when the footwear type is the predetermined footwear type and at least one of the interior temperature or the exterior temperature exceeds the threshold value.

9. The control system of claim 1, wherein the interior temperature exceeds the threshold value when the interior temperature is below the threshold value.

10. The control system of claim 1, wherein the interior temperature exceeds the threshold value when the interior temperature is above the threshold value.

11. A control system comprising:
at least one temperature sensor at a footwell of a vehicle;
an imaging device positioned at the footwell; and
a controller communicatively coupled to the temperature sensor and the imaging device, the controller configured to:
determine a temperature of the footwell from a temperature signal received from the at least one temperature sensor,
determine a footwear type from image data received from the imaging device, and
direct air to the footwell when the footwear type is a predetermined type and the temperature of the footwell is below a threshold value.
